(19) United States
(12) Patent Application Publication
(10) Pub. No.: US 2009/0271715 A1
(43) Pub. Date: Oct. 29, 2009

(54) COLLABORATIVE AUGMENTED VIRTUALITY SYSTEM

(76) Inventor: Ramakrishna J. Tumuluri, Hyderaba (IN)

Correspondence Address: Ramakrishna J. Tumuluri, Plot #46, Villa-Greens, Gandipet, Hyderabad, Andhra Pradesh, 500075, IN

(21) Appl. No.: 12/021,303

(22) Filed: Jan. 29, 2008

(51) Int. Cl. G06F 3/048

(52) U.S. Cl. 715/757; 715/733

(57) ABSTRACT

A system for use on a computer network 112 where multiple users can simultaneously experience “Virtual Worlds” 102 augmented with inputs from the real world via instruments such as Microscopes, Telescopes, 3D scanners etc. These “Collaborative Augmented Virtuality” systems can be made to be compliant with “laws of science” using “Science Engines” 108. Changes in the system can be persistent into local database(s) 160.

### TECHNICAL FIELD OF THE INVENTION

The present invention relates to an “Augmented Virtuality” system based on computer-network and instruments that provide images, videos and models from the “Real World”.

### DESCRIPTION OF THE RELATED ART

Augmented reality is the technology in which a user's view of the real world is enhanced with additional information generated from a computer model, i.e., the virtual. The enhancements may include labels, 3D rendered models, or shading and illumination changes. Augmented reality allows a user to work with and examine the physical world, while receiving additional information about the objects in it. Some target application areas of augmented reality include computer-aided surgery, repair and maintenance, facilities modification, and interior design.

In a typical augmented reality system, the view of a real scene is augmented by superimposing computer-generated graphics on this view such that the generated graphics are properly aligned with real-world objects as needed by the application. The graphics are generated from geometric models of both virtual objects and real objects in the environment. In order for the graphics and video of the real world to align properly, the pose and optical properties of real and virtual cameras of the augmented reality system must be the same. The position and orientation (pose) of the real and virtual objects in some world coordinate system must also be known. The locations of the geometric models and virtual cameras within the augmented environment may be modified by moving its real counterpart. This is accomplished by tracking the location of the real objects and using this information to update the corresponding transformations within the virtual world. This tracking capability may also be used to manipulate purely virtual objects, ones with no real counterpart, and to locate real objects in the environment. Once these capabilities have been brought together, real objects and computer-generated graphics may be blended together, thus augmenting a dynamic real scene with information stored and processed on a computer.

In order for augmented reality to be effective, the real and virtual objects must be accurately positioned relative to each other, i.e., registered, and properties of certain devices must be accurately specified. This implies that certain measurements or calibrations need to be made. These calibrations involve measuring the pose, i.e., the position and orientation, of various components such as trackers, cameras, etc. What needs to be calibrated in an augmented reality system and how easy or difficult it is to accomplish this depends on the architecture of the particular system and what types of components are used.

The earliest computer programs that attempted to depict real-world like scenes in 3D were created by programming in high-level programming languages such as ‘C’ or ‘C++’. Then, in the nineties a wave of markup languages such as “VRML” were developed, which could perform similar functions. These, were referred to as “3D Virtual Worlds” or “Virtual Worlds”. Independent programs called “VRML Browser” could interpret these “Markup Language” based descriptions and render them. This enabled the rapid creation of many “3D Virtual Worlds” much like HTML based websites. VRML also had the notion of “interactivity” built into it. One could interact with the 3D scene using computer peripherals such as a “mouse” or a keyboard. These “Virtual Worlds” could be authored, distributed and rendered on many desktop computers. However these approaches were constrained by their architecture. The “client-server” approach made it hard for different architectures to be evolved. Further these “browsers” were mainly designed to be “plug-ins” of the popular “web browsers” such as “Internet Explorer”, “Netscape”, Mozilla, etc. These two limitations limited the choice of architectures that they were deployed in. Some implementations of such browsers are at http://www.parallelgraphics.com, http://www.bitmanagement.com etc.

Further some experiments have begun to be performed where-in the “Virtual Worlds” are augmented with images and videos obtained from the real-world. e.g. “http://www.instantreality.org”. However they do not possess capabilities that allow for collaborative use.

In these implementations there is a lot of emphasis on “Visualization”. The behaviour of objects is not emphasised. Consequently, there is some un-naturalness to the “Virtual Worlds”. In some rare instances when behaviour is coded into the scene, it is impossible to change it at runtime.

### REFERENCES

Augmented Virtuality: http://en.wikipedia.org/wiki/Augmented_virtuality
VRML97: “Virtual Reality Modelling Language” standard approved and frozen in 1997. http://www.web3d.org/x3d/specifications/vrml/ISO-IEC-14772-VRML97/
X3D: The successor to VRML97. Contains XML encoding and profiles that allow for increasing levels of complexity to be adopted.
http://www.web3d.org/x3d/specifications/#x3d-spec
EAI: External Application Interface. A interface standard that was part of VRML97. It allowed for bi-directional access to the SceneGraph from languages such as Java. It also allowed for access to events of type EventIn and EventOut. http://www.web3d.org/x3 d/specifications/vrml/ISO-IEC-14772-VRML97/
SAI: Scene Access Interface. The modem version of EAI. It is a part of the X3D standard. http://www.web3d.org/x3d/specifications/#x3d-spec
LMS: Learning Management System.
http://en.wikipedia.org/wiki/Learning_Management_System
“Virtual Worlds”: These are representation of real worlds as expressed in Vrml97 or X3D. They contain 3d models of objects, have a SceneGraph representation, have interactivity, have sensors such “touch sensor”.
“BS Contact Vrml97/X3D”: http://www.bitmanagement.com/products/bs_contact_vrml.en.html
TCP/IP: “Transmission Control Protocol”/“Internet Protocol”. The protocols that power the internet.
LAN: Local Area Network. e.g. ethernet
WAN: Wide Area Network.
Java: A popular Computer Programming Language. http://www.javasoft.com
http://www.w3.org/TR/XQuery/ for XQuery and related technologies.
http://www.openoffice.org for OpenOffice and ODF file format.
http://www.opensourcephysics.org, NSF funded, education oriented, free to use

### BRIEF SUMMARY OF THE INVENTION

Accordingly, it is an object of the present invention to provide a system wherein a “Virtual Reality” system is augmented with inputs from the “real-world” to create an “Augmented Virtuality” system. This enables an end-user to experience and interact with this “Augmented Virtuality” system that is far richer than anything in the “real world” or via “Virtual World”. For e.g. in a preferred embodiment of e-Learning a “Virtual Reality” model of living-cell can demonstrate it's structure, shape, components etc. When this is augmented with images obtained from a Microscope of similar cells the learning-experience is far more compelling.

It is another object of the present invention to provide a “Collaborative Augmented Virtuality” system where an end-user can experience and interact with the system along with buddies from his buddy-list. This creates a “Collaborative Augmented Virtuality” experience. For e.g. in a preferred embodiment of e-Learning a teacher and student could conduct an online learning session with material expressed in an “Augmented Virtuality” system. This experience is far more compelling than a face-to-face interaction of a real-world. It is also far richer and compelling than a pure online learning situation, wherein the student is merely interacting with a computer or internet based application.

It is further object of the present invention to provide persistent and non-persistent methods of synchronization in the “Collaborative Augmented Virtuality” system. In the non-persistent method, changes made to a user's system are reflected in his buddies system. However these changes will not persist beyond the duration of the collaboration session. In the persistent “synchronization” method, changes made to any of the participant's system and that of his collaborating buddy, can persist long after the session is over. For e.g., in a preferred embodiment of e-Learning, a student and teacher can both take notes which can be synchronized with each other and in the case of persistent-synchronization, the changes can stay with both the participant's system, well after the session is completed.

It is further object of the present invention to provide a real-time synchronized slide-show on participating computers. Actions such as “forward”, “backward”, “stop” etc can be synchronized amongst buddy systems that are participating in the session. For e.g. in a preferred embodiment of e-Learning while a presentation is being made on the topic of “living cells” the teacher can navigate within the presentation, with commands such as “forward” or “backward” and these changes are instantaneously propagated to the student's system. This causes a feeling in the teacher and student as though, they are in the same room even though they could be geographically quite apart from each other.

It is another object of the present invention to provide a real-time synchronized video-show on participating computers. Actions such as “play”, “stop”, “fast-forward”, “rewind”, etc can be synchronized amongst participants of a session. For e.g. in a preferred embodiment of e-Learning, a teacher can show a “video” on a certain topic to students. Whenever the teacher plays the video on his computer, it will play the same video on a student's computer. This way a student and teacher get the feeling of being in the same room even though they could be geographically quite apart from each other.

It is another object of the present invention to provide a system where Rules of “physics” can be brought to bear collaboratively on the “Virtual World”. For e.g. in a preferred embodiment of e-Learning a teacher can demonstrate the effects of “Gravity” on physical objects within a “Virtual World” and students that are participating in the session will experience it as though they are in the same room, even when they are geographically quite apart from each other.

It is another object of the present invention to provide a system where Rules of “Chemistry” can be brought to bear collaboratively in the “Virtual World”. For e.g. in a preferred embodiment of e-Learning if models of Sodium (Na) and a Chlorine atom were brought together sufficiently the compound NaCl or common salt would be produced with chemical properties of common salt. A teacher can demonstrate this on his computer and students participating in this session will experience this on their respective computers as though they were in the same room, even though they may be geographically quite apart from each other.

It is another object of the present invention to provide a system where Rules of “Biology” can be brought to bear in the “Virtual World”. For e.g. in a preferred embodiment of e-Learning in a “Virtual World” of living cells, a cell can be made to divide on an appropriate trigger. If this experiment were conducted on a teachers computer, it can be experienced by a student at the same time, as though they were in the same room, even though they may be geographically quite apart from each other.

It is another object of the present invention to provide for a collaborative experience in using a “Telescope”, “Microscope” or some imaging-equipment For e.g. in a preferred embodiment of e-Learning a teacher can generate and demonstrate images or video created from a remotely operated telescope or microscope and share it in real time with their students. This experience is as though the teacher and student were in the same room, even though they could be geographically quite apart from each other.

It is another object of the present invention to provide for a collaborative experience in using a 3D scanner. For e.g. in a preferred embodiment of e-Learning a teacher can produce and share a “3D model” of any object under consideration for learning and share it with a student. This creates an experience for the teacher and student as though they were in the same room even though they could be geographically quite apart from each other.

### BRIEF DESCRIPTION OF THE DRAWINGS

The preferred embodiments of the invention will hereinafter be described in conjunction with the appended drawings provided to illustrate and not to limit the invention, wherein like designations (reference numbers) denote like elements, and in which: refer to similar elements throughout the figures.

FIG. 1 is a flowchart, which shows authentication and selection of mode, i.e. “single-user” or “multi-user”.

FIG. 2 is a schematic for “single-user” mode that demonstrates the augmentation of the “real” and “virtual” world.

FIG. 3 is a block-diagram of the two ways of achieving synchronization in a “Collaborative Augmented Virtuality” system i.e. “persistent” and “non-persistent”.

FIG. 4 is a block-diagram that demonstrates how a “Science Engine” helps enforce “laws of Science” in a “Augmented Virtuality” system.

FIG. 5 demonstrates how events are packaged up as “Java objects” and remoted, that enables “Collaboration” features in the “Collaborative Augmented Virtuality” system.

FIG. 6 is a flow-chart that demonstrates the flow of “User originated events” and “Scene originated events” to the local system or for remoting.

FIG. 7 demonstrates a data-structure that models a SceneGraph, an abstraction of a “Virtual World”.

FIG. 8 is an alternative embodiment in e-Medicine, where pathological samples of infected tissue are taken from a Microscope. They are used in conjunction with “Virtual Models” of the same tissue to develop an accurate understanding of the state of the tissue.

FIG. 9 is another alternative embodiment in e-Insurance, where 3D models of automobiles involved in a road accident are obtained from “3D Scanners”. They are used in conjunction with “Virtual Models” of the same automobiles to develop an accurate understanding of a traffic accident scene.

### DETAILED DESCRIPTION OF THE PREFERRED EMBODIMENTS

The detailed description of this invention is illustrative in nature and is not intended to limit the invention or the application and uses of the invention. Furthermore, this invention is not intended to be bound by any expressed or implied theory presented in the preceding technical field, background, brief summary or the following detailed description.

This invention will now be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

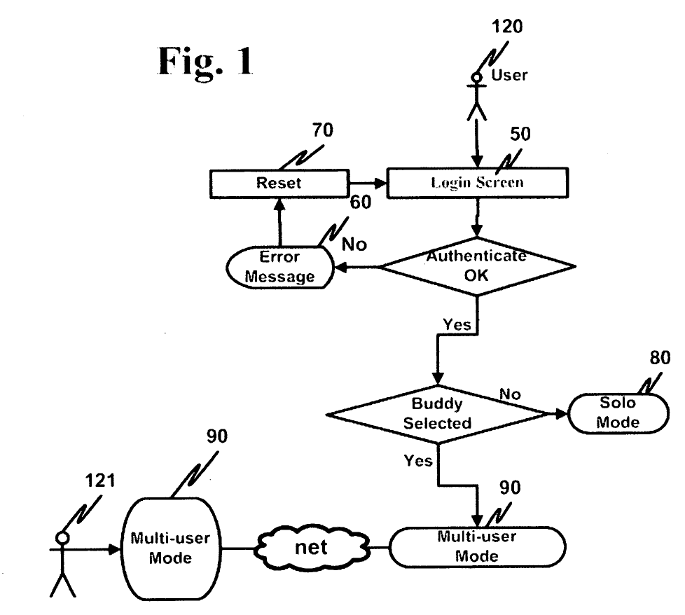

FIG. 1 is a flow-chart detailing the “authentication” phase and “mode selection” phase of the system. A user 120 starts his session by logging into the “login screen”50. If authentication fails than a “error-message” 60 is presented to the user. The user can reset 70 and try again. If authentication succeeds, the user is offered a choice of modes. He can choose a “solo mode” or a “multi-user” mode. The “solo mode” 80 is the simpler option and he interacts with the application solely. In the “multi-user” mode 90 a user interacts with the application and with his buddy 121. A “buddy” is a fellow user with whom the user chooses to engage in a “collaborative” activity. A list of buddies is called a “buddy list”. The “buddy list” for every user gets developed and maintained via a separate-interface provided to the user.

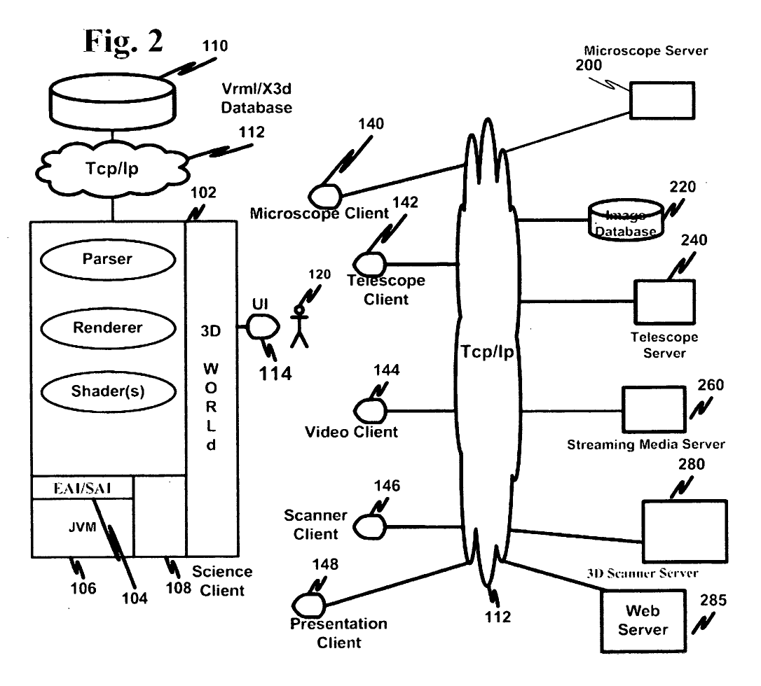

FIG. 2 is a schematic of an “Augmented Virtuality” system as conceived in this invention. 102 is a standards compliant browser that can interpret, render and provide interactivity for any “Virtual World” described in Vrml97/X3D. It contains many objects such as geometries, sensors, interpolators etc. These are abstracted into a structure called a SceneGraph that is an upside-down tree. It also contains an programming interface 104 called EAI in the Vrml97 standard and SAI in the X3D standard. This interface provides access to the SceneGraph to carry out many functions, such as changing the color of an Geometry. In the current embodiment the EAI/SAI interfaces are conceived in an Java environment. 106 is a JVM (Java Virtual Machine) and is the runtime environment for many Java programs to communicate with the “Virtual World” via the EAI/SAI interfaces. 108 is a “Science Engine” interfaced to the SceneGraph via the EAI/SAI interface. The “Science Engine” has three constituent parts, a “Physics Engine”, “Chemistry Engine” and “Biology Engine”. The “Physics engine” implements laws of physics that are enabled. (E.g. enable gravity). The “Chemistry engine” implements laws of chemistry that are enabled. (E.g. an electro-negative ion such as chlorine and an electro-positive ion such as Sodium will bond to form a new compound such as NaCl or common-salt). The “Biology engine” implements laws of biology that are enabled. (E.g. on a proper trigger a living cell will divide). These science engines take their directives via Markup languages such as PhysicsML, ChemistryML and BiologyML. 112 is any computer network such as the TCP/IP based internet. 114 is a general-purpose User-Interface that ties all other programs that are presented to the end-user. The end-user 120 uses the “Collaborative Augmented Virtuality” system.

140 is a Microscope client. It helps the end-user to operate a remote-microscope across a computer network. It can also accept and display any image produced by the Digital Microscope that it is connected to. 142 is a Telescope client. It is used to operate a remote-controlled telescope across a network. It can also accept and display any image produced by the Digital Telescope that it is connected to. 144 is a Video client that is collaborative. It enables the end-user to play videos obtained from the video-server. It also enables a user to collaborate on the playing experience with buddies in his buddy list. 146 is a scanner client. It enables an end-user to control a remote-controlled 3D scanner via a computer network. 3D scanning produces a 3D model. 148 is a presentation client that is collaboration-enabled. It is built on top of the “impress” program from the OpenOffice suite. (http://www.openoffice.org). It allows an end-user to play a presentation such as a “Microsoft PowerPoint” presentation. It also allows any user to have the playing experience be collaborative with buddies on his buddy list.

200 is a Microscope server. It is a sub-system containing a digital-microscope and server that is attached to it. This allows a corresponding microscope-client as in 140 to operate the microscope from across any computer network such as the tcp/ip based internet. 220 is an image database that contains images fetched, sorted and stored from the digital microscope, digital telescope or such similar imaging equipment. 240 is a Telescope server. It is a sub-system that contains a digital telescope and a server that is attached to it. This allows a corresponding telescope-client to operate the telescope from across a computer network including the tcp/ip based internet. 260 is a media streaming server. It can serve video streams across any computer network such as the tcp/ip based internet. 280 is a 3d scanner server. It has the capability of scanning any physical object. It can be operated using a corresponding client across a computer network such as the tcp/ip based internet.

Thus an end-user using the current invention in a “solo” mode can experience a “Virtual World’ augmented with inputs from the “Real” world. Hence the usage of the term “Augmented Virtuality” in this invention. In the preferred embodiment of an e-Learning situation, the end-user downloads a presentation to be played in his Presentation client” 148. Operations permissible in such situations are “play”, “stop”, “fast-forward”, “rewind” etc. Using these controls a user experiences the presentation. In any slide of the presentation, he is offered a “video” or “3D model” to augment his learning. A video is played using the “video client” 144. The “models” are experienced using the “Vrml97/X3D Browser” 102. He can do many operations with the Vrml97/X3D model such as “zooming”, “panning”, “rotating”, and many such operations as defined in the Vrml97/X3D specification. He can also experience the usage of a remote microscope using the Microscope client 140. Operations such as “moving a slide”, “zooming”, “changing a slide” are enabled. He can also view various distant objects using a telescope client 142. Operations such as “zooming”, “panning” are enabled. Scanner client 146 enables him to scan objects via the “3D scanner server”. These 3D scanned objects can be formatted in various formats such as Vrml97/X3D and saved to hard-disk for further action. In this way a user can visualize any “Virtual World” and augment it with various real world instruments such as a “Microscope” or “Telescope”. In the preferred embodiment of a e-Learning application, a class on “living cells”, a “Virtual world” of living cells is experienced on a “Virtual World” browser 102 and is augmented by slides of “living cells” such as bacteria using the Microscope client 140.

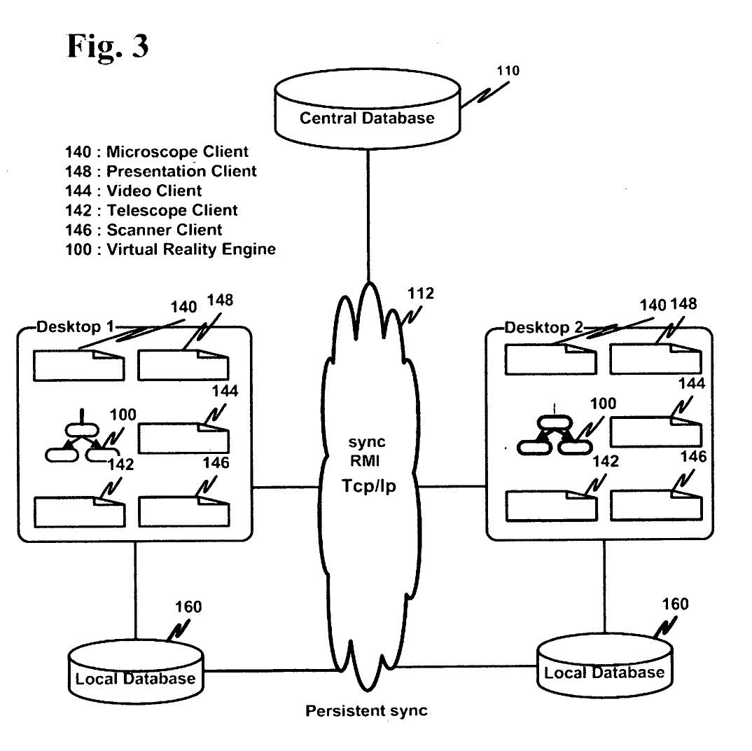

FIG. 3 is a schematic that details various mechanisms for synchronization in the “Collaborative Augmented Virtuality” system. Various clients on an end-user's desktop such as a “Virtual Reality Engine” 100, Microscope client 140, Telescope client 142, Video client 144, Scanner client 146 and Presentation client 148 are enabled with Java RMI technology in a way such that any “event” handled on these said clients can be packaged up as Java Object and “remoted”. This allows those clients to become collaborative with buddies that are on the particular end-user's buddy-list. This mechanism of “synchronization” is termed non-persistent since it looses it's capability on termination of a session. The second method of “synchronization” is performed using the local database 160. It is an XML database with replication capability. This implies that any change persisted to the local database can be replicated to another similar database of a “buddy” on the end-user's buddy-list. Since the XML database persists to a hard-disk, this type of synchronization stays across a session's lifetime and is termed “persistent synchronization”. Thus two or more users of this system can stay “synchronized” w.r.t any change even when they are using the system across a computer network. In the preferred embodiment of e-Learning a teacher and student in a learning session can interact with a “Virtual World” together, for e.g. in a class on “living cells”, if the teacher opens up a cell into it's constituent parts, then at the same time this can be experienced by the student. This creates a compelling learning experience. Similarly if a microscope is used to study some bacterial cells and some observations are made, they can be written to disk via the XML database, by the student. The teacher instantly gets those changes via the underlying database replication. These notes can be used by the teacher for other sessions, with other students. This creates a very compelling user experience in a group.

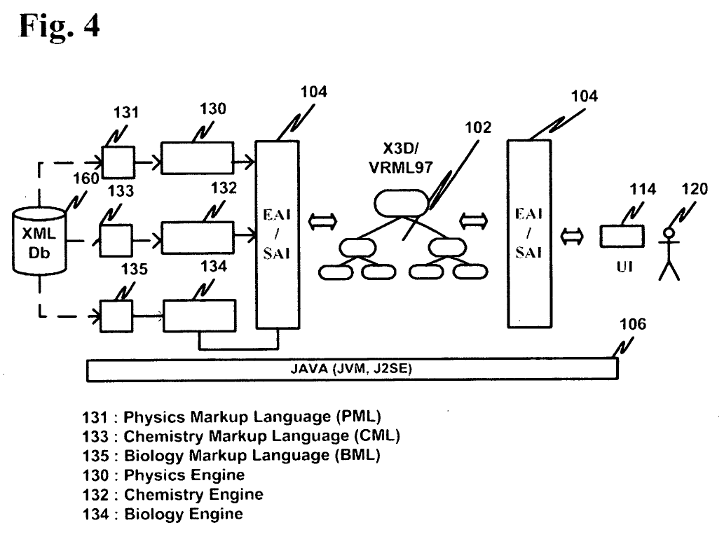

FIG. 4 is a schematic of a “Science Engine” in the “Collaborative Augmented Virtuality” system.

It has three constituent components. They are a “Physics Engine” 130, a “Chemistry Engine” 132 and a “Biology Engine” 134. These engines interpret directives defined in their corresponding Markup Language specifications. For e.g. the “Physics Engine” interprets and enforces the “PML specification” 131. One example of a PML specification is “turn on Gravitational force at the value of Universal Gravitational Constant”. Similarly the “Chemistry Engine” interprets and enforces laws of Chemistry as specified in the “CML specification” 133. For e.g. if an electro-negative ion and electro-positive ion come close together than an electro-valent bond is formed and a new compound with different properties is created. Similarly the “Biology Engine” interprets and enforces laws of Biology as specified in the “BML specification” 135. For e.g. when an appropriate trigger is applied a human cell undergoes “cell division”. The engines are interfaced to the Vrml97/X3D browser via the EAI/SAI interface 104. The three markup specifications (PML, CML and BML) are stored in an XML database 160. Different end-user's of the “Collaborative Augmented Virtuality” system could synchronize their XML databases using database replication technology. Thus a “persistent” synchronization as described in FIG. 3 is enabled for the “Science Engine” directives also.

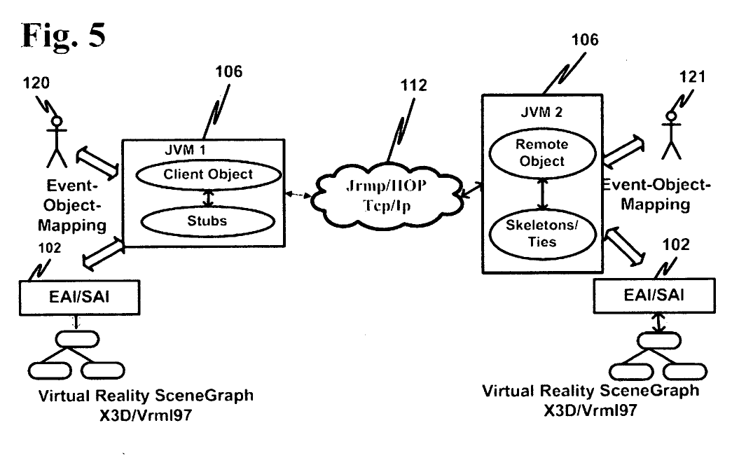

FIG. 5 is a schematic that details how events are transported in the “Collaborative Augmented Virtuality” system. Events are generated from an end-user 120 or from within the SceneGraph of a “Virtuality System” 102. These events are packaged up as Java objects and “remoted” by the RMI technology of a “Java Standard Edition” environment 106. The default protocol of JRMP is used when the firewalls of the participating networks permit it, else the more widely allowed IIOP protocol is used. When the local JVM needs to call methods on these “Event Objects”, they follow the normal rules of execution in a Java Environment. During remote operation the “stubs” of these objects are made available in the “remote” JVM. These stubs communicate with their paired skeletons such that for all practical purposes the remote environment will react to the event as though it was locally generated. This creates the illusion of “real-time” collaboration in the “Virtual Reality” environment. This is the underlying plumbing that makes the “Collaborative” aspect of the “Collaborative Augmented Virtuality” system work.

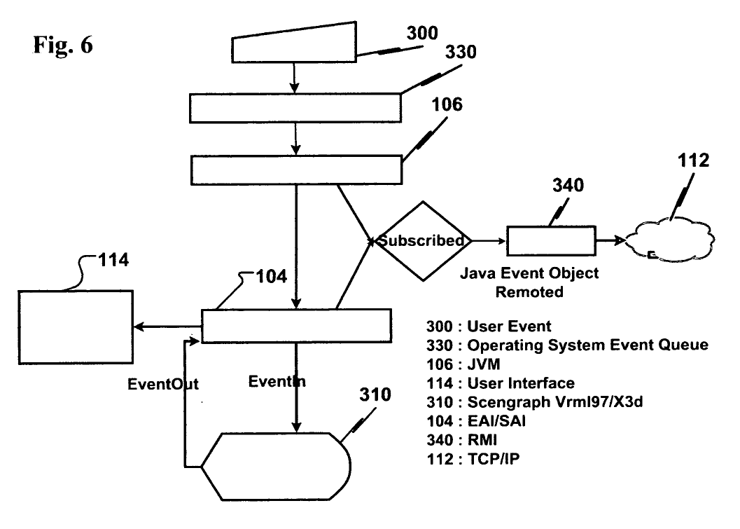

FIG. 6 is a flow chart that describes the flow of events within the “Collaborative Augmented Virtuality” system. An end-user event 300 is generated using a computer peripheral such as a keyboard or mouse. It is “caught” by the operating system 330 and passed on to the Java Virtual Machine 106. If the event was subscribed by other buddies of the current user than those events are passed to the RMI subsystem 340 and made available for use across a computer network 112. The event makes a call on an appropriately registered listener on the remote machine. On the other hand if the system is in “solo” mode than that event is passed only to the SceneGraph 310 via the interface EAI/SAI 104. It is handled as an EventIn of the Vrml97/X3D standard. Based on the routing logic in the SceneGraph a series of changes occur in the SceneGraph. For e.g. a ball may fall from it's perch and start bouncing up and down. Events generated from within the SceneGraph called EventOut's are made available for local or remote use via the EAI/SAI interface 104 as Java Objects. For e.g. in a preferred embodiment of e-Learning, in a SceneGraph of “living cells” certain ions could move across a cell-membrane by osmosis and when that threshold occurs an EventOut would emerge from the SceneGraph. This EventOut is available as a Java Object across the EAI interface in the Vrml97 Standard or the SAI interface in the X3D standard.

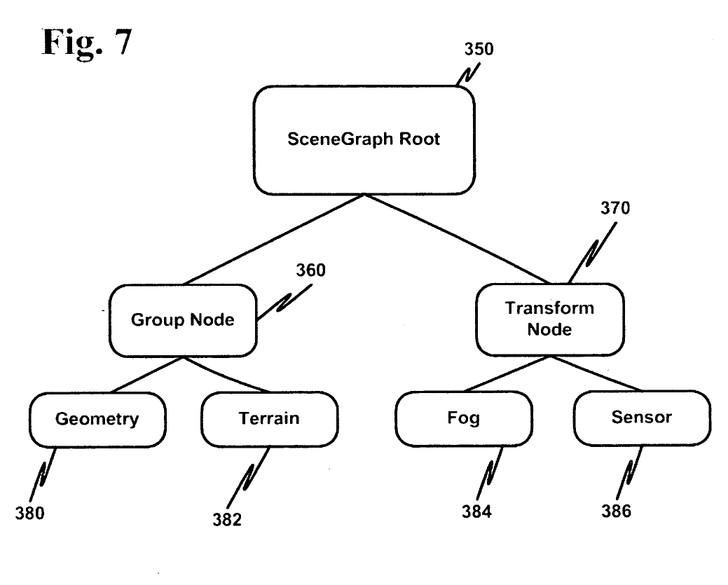

FIG. 7 describes a basic SceneGraph abstraction of a “Virtual World”. The structure is like an “inverted tree”. 350 is the root of the graph. There is only a single root for the entire graph. 360 “Group node” and 370 “Transform node” are representative nodes that are “Grouping nodes”. 380 is a Geometry node and contain geometry structures such as a sphere. 382 is an example of Terrain node. It can model terrains such as “grass”. 384 is an example of nodes such as a “Fog” node that attempt to characterize the environment. 386 is a sensor node. It models things such as a cylinder-sensor. These are all part of the standard Vrml97/X3d standard.

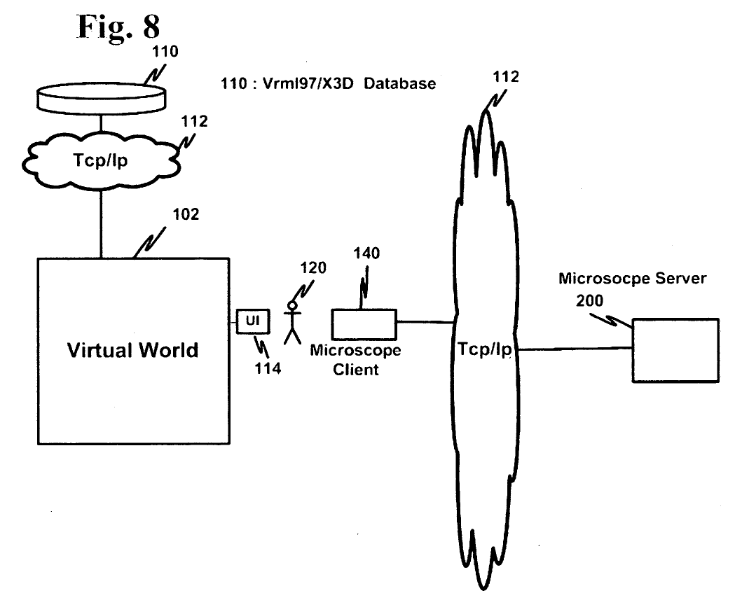

FIG. 8 shows an embodiment of this invention in a remote-medicine or e-Medicine scenario. A remotely located technician could take microscopic samples of a patient's tissue and use this invention to share it with the Doctor. This is done using the Microscope server 200 and client 140. The doctor could use the tissue-sample provided by the remote technician and compare it with a “Virtual World” model of a similar healthy tissue. This will enable the doctor to develop a clearer understanding of the situation and can consequently device an appropriate treatment. On completion of the treatment, this exercise could be conducted again to ensure that the tissue under consideration is back to its normal healthy state. This enables remotely located patients to get excellent medical care. It also enables many doctor's to provide their services to rural areas, thereby increasing their opportunity and satisfaction.

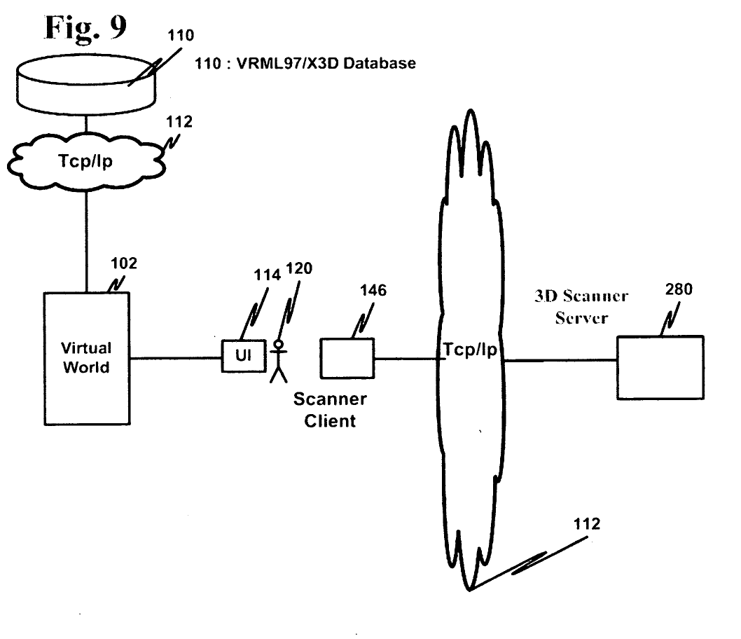

FIG. 9 shows an embodiment of this invention in an “automobile insurance” or e-Insurance situation. On learning of an accident and processing a claim for body-work the insurance company can request a “3D Scan” of the damaged car under consideration. This is done using the “3D scanner” and associated server 280 and client 146. The insurance company can compare and contrast the 3D model obtained against a known 3D model of a brand new car of the same make and type. By doing this they can accurately assess the damage and estimate the repair cost. This saves the insurance company time and money. It also makes for effective and painless process for the consumer.

### ADVANTAGES

From the above description a number of advantages of my “Collaborative Augmented Virtuality System” become evident:

Any topic of interest can be experienced in a rich, compelling manner wherein a “Virtual World” realization of a topic-of-interest is augmented with inputs from a number of real-world such as “Telescope”, “Microscope”, “3D-Scanners” etc. For e.g. in the preferred embodiment of e-Learning, a student could visualize and interact with “Virtual World” of living cells, augmented with cultures and slides from Microscopes.

The collaborative feature of the “Collaborative Augmented Virtuality” system allows more than one person to “collaborate” with each other w.r.t the “Virtual World” or the augmenting real-world inputs comprising of images, videos and 3D models. When these methods are enhanced using well-understood technologies such as “telephony”, “video-conferencing”, “internet-chat”, “internet-forums”, email etc, it creates a very compelling collaboration experience. In the preferred embodiment of e-Learning a teacher while teaching a class on “living cells” could demonstrate “3D-models” or “Virtual World” of “cells” to his student and they can both interact with it in real-time. They could peek into the parts of the cell simultaneously as though they were in the same room. They could operate a network controlled microscope and look at the images produced of cell slides in real time. This creates an experience that is far more compelling than when a student and teacher are in the same room.

The “Science Engine” component enables the “Virtual World” to simulate “laws of science”. In the preferred embodiment of e-Learning, for e.g. scenarios such as the following are possible. Physical objects can be made to obey “laws of Gravity”. An object will only fall down towards the earth, dependent on the gravitational force. Chemically active objects for e.g. Sodium (Na) and Chlorine (Cl) when brought together engage in a chemical reaction to produce a new compound, namely common-salt (NaCl). This common-salt has an entirely new set of chemical properties. A living cell can be made to divide itself into newer cells on getting the right trigger.

Users participating in a “Collaborative” session can synchronize changes in a “persistent” or “non-persistent” manner. In the preferred embodiment of e-Learning when a session on “living cells” is being conducted, the teacher can demonstrate a “cell division” process on his computer. At the same time this process will also happen on the student's computer. If the student would like to make a note on this process, he can choose to make it persist, so he can share this with a fellow student at a later time.

The “Virtual World” realization of any object in augmentation with a “3D scanned” model enables many possibilities. In the additional embodiment of e-Insurance, an insurance agent can assess the “damaged” body of an automobile and compare it with the “Virtual World” embodiment of the original car created at design time. This enables them to come up with an assessment that is accurate, defendable and cheaper.

What is claimed is:

1. A computer-network based “Collaborative Augmented Virtuality System” that comprises standards compliant browser having plurality of objects and programming interfaces to interpret, render and/or provide interactivity to “Virtual world”, a remoting system on the network to enable packaging of events into network objects which is invoked from across a computer network and to communicate with the virtual world through the programming interface, an Engine interfaced to a SceneGraph through the programming interface and plurality of client-server systems across any of computer network.

2. The “Collaborative Augmented Virtuality System” as claimed in claim 1, wherein the system further comprises
a. an interactive, 3d representation of a given topic; and
b. an image and/or Video and/or “3D model” representation of said topic obtained from plurality of instruments which augments the “virtual reality”.

3. The “Collaborative Augmented Virtuality System” as claimed in claim 1, wherein the plurality of objects are abstracted into the SceneGraph structure from a group comprising objects from the “Virtual World” such as geometries, interpolators, sensors etc and that are augmented from the “Real World”.

4. The Collaborative Augmented Virtuality system as claimed in claim 1, wherein the engine is Science Engine further comprises Physics engine, Chemistry engine and biology engine.

5. The Collaborative Augmented Virtuality system as claimed in claim 4, wherein the physics engine implements laws of physics, the chemistry engine implements laws of chemistry; the biology engine implements laws of biology and these science engines interpret directives predefined in their corresponding Markup Language specifications PhysicsML, ChemistryML and BiologyML respectively.

6. The Collaborative Augmented Virtuality system as claimed in claim 1, wherein the programming interface is an EAI in the Vrml97 standard and/or SAI in X3d standard and these interfaces are conceived in java environment.

7. The Collaborative Augmented Virtuality system as claimed in claims 1 and 6, wherein the programming interface provides access to the SceneGraph to carry out plurality of functions selected from a group such as changing color of geometry, changing size of the geometry and other related functions.

8. The Collaborative Augmented Virtuality system as claimed in claim 1, wherein the system further comprises general-purpose User-Interface to tie all other programs that are presented to end user where the end user uses the “Collaborative Augmented Virtuality” system.

9. The Collaborative Augmented Virtuality system as claimed in claim 1, wherein the plurality of client server systems are collaborative systems selected from a group comprising microscope client-server, telescope client-server, video client-server, scanner client-server and presentation client-server systems or a combination thereof.

10. The Collaborative Augmented Virtuality system as claimed in claim 9, wherein
a. the microscope client enables the end user to operate a remote-microscope across a computer network and to also accept and display any image produced by the digital microscope to which it is connected with help of said microscope server;
b. the telescope client to enables the end user to operate a remote-controlled telescope across a network and to also accept and display any image produced by the digital telescope to which it is connected with help of said telescope server;
c. the video client enables the end-user to play videos obtained from the video-server and to also enables the user to collaborate on the playing experience with buddies in his buddy list;
d. the scanner client enables the end-user to control a remote-controlled 3D scanner through the computer network using the scanner-server; and
e. the presentation client built on top of “impress” program to enable the end-user to play a presentation and to also enable the user to collaborate on the playing experience with buddies in his buddy list.

11. The Collaborative Augmented Virtuality system as claimed in claim 6, wherein the “Science Engine” is expressed using markup languages, enabling advanced “Semantic Querying”, comprising,
a. Specification of Scientific assertions in an XML language preferably RDF (Resource Description Framework),
b. Specification of an ontology of laws in an XML language preferably OWL (Web Ontology Language), and
c. Storage of the “assertions” and “ontology” in an XQuery enabled XML Database.

12. The Collaborative Augmented Virtuality system as claimed in claims 1 and 2, wherein the system enables changes made in the user's environment to persist even after the system is shutoff, with the help of sub components provided in the system comprising
a. an XML database engine to store the SceneGraph that describes the “Virtual Reality” world;
b. said “XML database” has a replication feature such that parts of the representation/schema are automatically replicated with other database engines that are setup to participate in the replication arrangement; and
c. a user-interface component allowing the user to control the “persistence mechanism” such as ON or OFF.

13. The Collaborative Augmented Virtuality system as claimed in claim 12, wherein the changes made to the “virtual world” by the end-user and/or by his buddies is persisted to permanent storage and among other things, “notes” and such metadata are also persisted with the “virtual reality” world.

14. The Collaborative Augmented Virtuality system as claimed in claim 1, wherein the remoting system on the network is a JAVA-RMI enabled system.

15. A method for computer-network based Collaborative Augmented Virtuality system comprising
i. generating an end-user events using computer peripheral and/or from within SceneGraph of the “Virtuality System”;
ii. parsing generated events by operating system and thereby passing parsed events on to java virtual machine to prepare network objects preferably Java event objects;
iii. remoting the objects onto RMI subsystem and thereafter transferring the objects over network; and
iv. invoking transferred objects by a registered client across the computer network into his native computer to display the end-user events.
